(19) United States
(12) Patent Application Publication
(10) Pub. No.: US 2013/0280674 A1
(43) Pub. Date: Oct. 24, 2013

(54) System and Method for Dental Implants

(71) Applicant: Michael C. Maksim, Oceanside, CA (US)

(72) Inventor: Michael C. Maksim, Oceanside, CA (US)

(21) Appl. No.: 13/454,990

(22) Filed: Apr. 24, 2012

(51) Int. Cl. A61C 8/00

(52) U.S. Cl. 433/173

(57) ABSTRACT

Systems and methods are provided that relate to a dental implant procedure. In one example, a dental implant method may include drilling an implant hole into a jaw bone. Gingiva adjacent to the implant hole may be removed to create a ledge portion in a bone surface surrounding the hole. The method may further include inserting a dental implant into the implant hole, the dental implant having a removably coupled healing abutment. The healing abutment may include a projection having a projection diameter greater than the implant hole diameter. As the implant is driven into the implant hole, the projection may stop advancement of the dental implant via contact between the projection and the ledge portion.

### FIELD

The present disclosure relates generally to the field of dental implants and dental implant procedures.

### BACKGROUND

Dental implant procedures may be performed by a variety of dental professionals, including oral surgeons, endodontists, periodontists and general dentists. Such procedures may present several challenges to a dental professional, and particularly to a professional with limited dental implant experience. For example, in preparing for the procedure, a desired drilling depth into a patient's maxilla or mandible is typically determined, as well as the location of vital structures such as the sinus cavity or the inferior alveolar nerve. Particularly in situations where the desired drilling depth approaches a vital structure, it is desirable for the dental professional to avoid exceeding the desired drilling depth. When using an osteotomy drill that has a potential drilling distance that is deeper than the desired drilling depth, the dental professional may visually estimate the depth of insertion, such as by referencing depth indicators on the body of the burr or blade. If the dental professional underestimates the depth of insertion while drilling, the drill may be advanced beyond the desired drilling distance and damage to a vital structure may occur.

In one example, a coring trephine drill may be used to create the osteotomy that will receive the dental implant. Once the coring trephine has been inserted into the bone to the desired depth, the cylindrical core of bone created by the trephine must be removed from the hole and the trephine. In some situations, depending on the width and length of the implant to be placed, a series of progressively wider and/or longer coring trephines may be used, thereby requiring multiple successive drilling steps that lengthen the duration of the procedure.

One challenge with drilling osteotomies can be avoiding thermal bone necrosis within the implant hole due to excessive temperatures created in the drilling procedure. To address this challenge, the osteotomy drill is typically irrigated with a fluid such as water or saline to cool the drill and avoid overheating. The irrigating fluid may be manually supplied to the drill and the implant site during portions of the procedure by an external irrigating wand that is held by a dental assistant. In some cases, however, this manual method of periodically delivering irrigating fluid to the drill via a hand-held wand or other instrument may be insufficient to effectively cool the drill, resulting in bone necrosis within the hole. Additionally, irrigating fluid from the wand and bone debris generated by the drill may collect in a patient's mouth, and may be periodically manually evacuated with a separate hand-held suction device. In some cases, such periodic manual evacuation of irrigating fluid and bone debris may be insufficient to prevent a build-up in the patient's mouth, which can result in a patient temporarily choking.

When the implant hole has been prepared, the implant may be placed or driven into the implant hole. A typical implant may take the form of a cylindrical titanium screw. One issue during placement of the implant may occur when a dental professional misjudges the distance of insertion and drives the implant through the floor of the implant hole, thereby compromising the chances for successful osseointegration and potentially damaging a nearby vital structure. After the implant has been placed, a potential complication with successful osseointegration of the implant can be poor initial stability of the implant within the implant hole. Additionally, during the healing process inadvertent contact with or loading of the implant may shift the implant within the implant hole and disrupt osseointegration that has previously occurred, which may result in implant failure. Significant axial loading of the implant during healing could also drive the implant through the floor of the implant hole and into a vital structure.

### SUMMARY

Embodiments are disclosed that relate to dental implant methods, systems, and related devices that may at least partly address one or more of the above issues. For example, one disclosed embodiment of a dental implant method includes drilling an implant hole into a jaw bone at an implant site, with the implant hole having an implant hole diameter. The method may include removing gingiva adjacent to the implant hole to create a ledge portion in the bone surface that surrounds the implant hole. The method may further include inserting a dental implant into the implant hole, the dental implant having a healing abutment that is removably coupled to the implant. The healing abutment may include a projection having a projection diameter that is greater than the implant hole diameter, such that as the dental implant is driven into the implant hole, the projection is configured to stop advancement of the dental implant via contact between the projection and the ledge portion.

Another disclosed embodiment of a dental implant method includes drilling an implant hole into a jaw bone and scoring a circular implant retention groove at a bottom floor of the implant hole. The method may include inserting a dental implant into the implant hole, with the dental implant including a circular lip that extends axially from a distal end of the implant. The method may further include seating the circular lip of the dental implant into the circular implant retention groove at the bottom floor of the implant hole.

Another disclosed embodiment of a dental implant method includes drilling an implant hole into a jaw bone at an implant site using only one osteotomy trephine drill, with the implant hole having an implant hole diameter. The method may include scoring a circular implant retention groove at a bottom floor of the implant hole using the osteotomy trephine drill. The method may further include removing gingiva adjacent to the implant hole using a site preparation trephine drill to create a ledge portion in the bone surface surrounding the implant hole. The method may also include inserting a dental implant into the implant hole, with the dental implant having a healing abutment that is removably coupled to the implant. The healing abutment may include a projection having a projection diameter that is greater than the implant hole diameter. Additionally, the dental implant may include a circular lip that extends axially from a distal end of the dental implant. The method may further include seating the circular lip of the dental implant into the circular implant retention groove at the bottom floor of the implant hole.

Another disclosed embodiment relates to a surgical guide system that may be used in a dental implant procedure. In one example, the surgical guide system may include a surgical guide for ensuring that a desired drilling depth into a jaw bone is not exceeded. The surgical guide may include a retention portion that secures the surgical guide in place. The surgical guide may also include an implant site portion that is joined to the retention portion. The implant site portion may comprise a cylindrical aperture that has a selected diameter and is located adjacent to an implant site. The selected diameter may be greater than a first diameter of a first osteotomy drill that has a first length. The selected diameter may also be less than a second diameter of a second osteotomy drill having a second length that is greater than the first length, such that the second osteotomy drill may not be inserted into the cylindrical aperture.

Another disclosed embodiment relates to a dental implant preparation system that may be used in a dental implant procedure. In one example, the dental implant preparation system may comprise a trephine drill that includes a cylindrical blade with a plurality of cutting teeth at a distal end. A shank may extend from a proximal end of the cylindrical blade. At least one internal blade may be within a diameter of the cylindrical blade. The at least one internal blade may include a leading edge adjacent to the distal end of the cylindrical blade, wherein the at least one internal blade is operable to remove bone or gingiva as the trephine drill is rotated and pressed into the bone or the gingiva.

Another disclosed embodiment relates to a dental implant system that may be used in a dental implant procedure. In one example, the dental implant system may include a dental implant having an implant shaft that extends between a proximal end and a distal end of the implant. The dental implant may include a thread that wraps in a helical fashion around the implant shaft between the proximal end and the distal end of the implant. An implant shaft socket may be located in the implant shaft adjacent to the proximal end of the implant. The dental implant may also include a circular lip that extends axially from the distal end of the implant, with the circular lip configured to seat into a circular implant retention groove at a bottom floor of a predrilled implant hole in a jaw bone.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE FIGURES

The present disclosure will be better understood from reading the following description of non-limiting embodiments with reference to the attached drawings, wherein:

FIG. 1 shows an embodiment of a surgical guide installed on the maxillary teeth of a patient, two trephine drills for drilling an implant hole and a guide cylinder that may be used in performing an embodiment of a dental implant method.

FIG. 2 shows an implant site portion of the surgical guide of FIG. 1.

FIG. 3 shows a cross-sectional view of an alveolar bone and maxillary sinus cavity, and an embodiment of an osteotomy trephine for drilling an implant hole through an implant site portion of a surgical guide.

FIG. 4 shows a cross-sectional view of an alveolar bone and maxillary sinus cavity, and an illustration of the osteotomy trephine of FIG. 3 drilling the implant hole.

FIG. 5 shows a cross-sectional view of an alveolar bone and maxillary sinus cavity, an implant hole having an implant retention groove, and an embodiment of a site preparation trephine used in preparing the implant site to receive the implant.

FIG. 6 shows a cross-sectional view of an alveolar bone and maxillary sinus cavity, and an embodiment of a dental implant that may be inserted into the implant hole.

FIG. 7 shows a cross-sectional view of an alveolar bone and maxillary sinus cavity with the dental implant of FIG. 6 inserted into the implant hole, and showing the circular lip of the implant seated in the implant retention groove at the bottom floor of the implant hole.

FIG. 8 shows a cross-sectional view of an alveolar bone and an embodiment of a dental implant inserted into the implant hole, with the implant having a plurality of serrated edges seated in an implant retention groove at the bottom floor of the implant hole.

FIG. 9 shows a cross-sectional view of an alveolar bone and maxillary sinus cavity, and an embodiment of a site preparation trephine that may be used to score a circular drilling guide groove in an implant site.

FIG. 10 shows a cross-sectional view of an alveolar bone and maxillary sinus cavity, and an embodiment of an osteotomy trephine for drilling an implant hole at an implant site that includes a circular drilling guide groove scored by the site preparation trephine of FIG. 9.

FIG. 11 is a perspective view of an embodiment of an osteotomy trephine having an internal blade for removing bone and/or gingiva.

FIG. 12 is a detailed perspective view of an embodiment of an osteotomy trephine drill having three internal blades for removing bone and/or gingiva.

FIG. 13 shows a cross-sectional view of an alveolar bone and maxillary sinus cavity, and an embodiment of a gingiva contouring drill that may be used to shape gingiva adjacent to an implant hole.

FIG. 14 is an exploded perspective view of an embodiment of a dental implant having a circular lip extending from a distal end, a healing abutment, a fastener, and a driver for driving the healing abutment.

FIG. 15 is a perspective view of the dental implant, fastener, and healing abutment of FIG. 14 is an assembled state.

### DETAILED DESCRIPTION

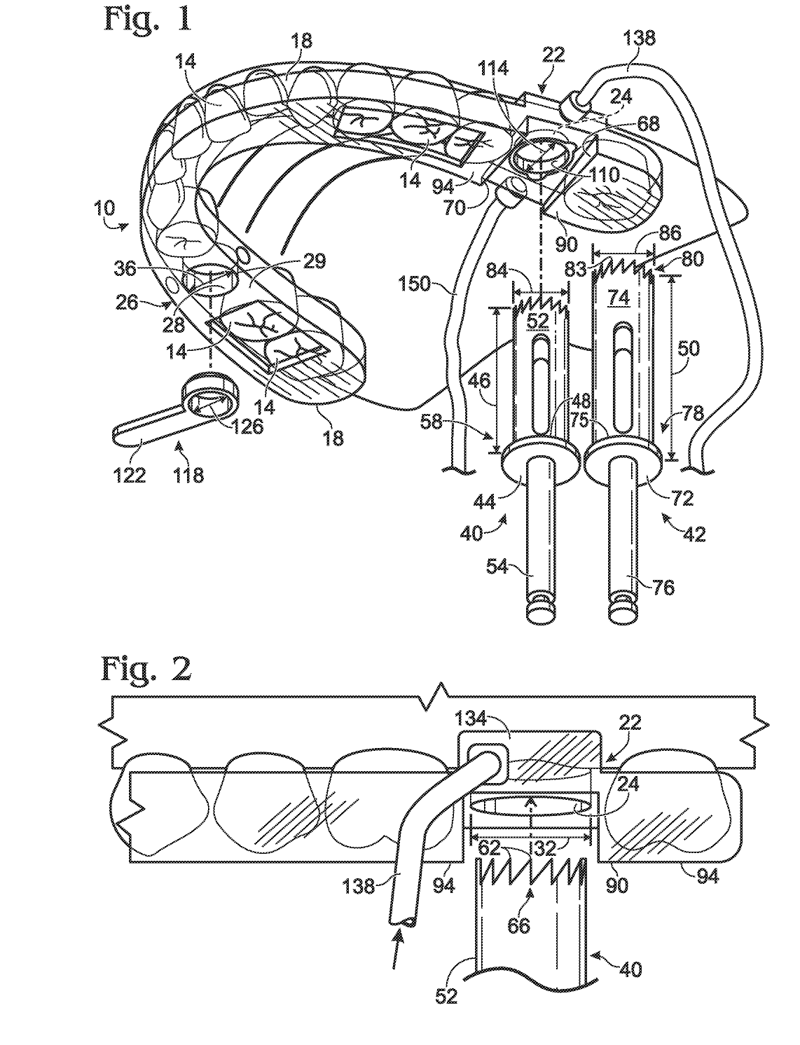

FIG. 1 shows a schematic illustration of an embodiment of a surgical guide 10 installed on maxillary teeth 14 of a patient. As explained in more detail below, the surgical guide 10 may be used in practicing an embodiment of a dental implant method according to the present disclosure. The surgical guide 10 may be produced from polycarbonate, other suitable thermoplastic polymers or other suitable materials. The surgical guide 10 may also be partially or substantially transparent, thus enabling a dental professional to see underlying teeth, gingiva and other structures.

The surgical guide 10 may be custom-molded for an individual patient. In one example, one or more radiographs and/or computed tomography (CT) scans of the implant area may be obtained to determine the shape and dimensions of bone in the implant area. A three-dimensional model of the patient's jaw and gums may be produced showing gum thickness, bone levels, locations of vital structures, and other useful information. Using such information along with the desired location and depth of the implant hole(s) to be drilled, a surgical guide 10 customized to a particular patient and dental implant procedure may be produced.

With reference to FIG. 1, the surgical guide 10 may include a retention portion 18 that secures the implant guide in place. In one example shown in FIG. 1, the retention portion 18 may comprise a portion of the surgical guide 10 that fits over and engages the patient's teeth to secure the implant guide in place. In another example, the retention portion 18 may comprise a portion of the surgical guide 10 that fits over and engages one or more of a patient's teeth, but less than all of the patient's teeth. In another example where all of the teeth in a patient's maxilla or mandible have been removed, the retention portion may comprise a portion of the surgical guide 10 that fits over bone surface or mucosa to secure the implant guide in place.

The surgical guide 10 may include one or more implant site portions according to the number of dental implants to be inserted. The one or more implant site portions are joined to the retention portion 18 in forming the surgical guide 10. In one example shown in FIG. 1, a first implant site portion 22 and a second implant site portion 26 are integrally formed with the retention portion 18 into a unitary molded structure that forms the surgical guide 10.

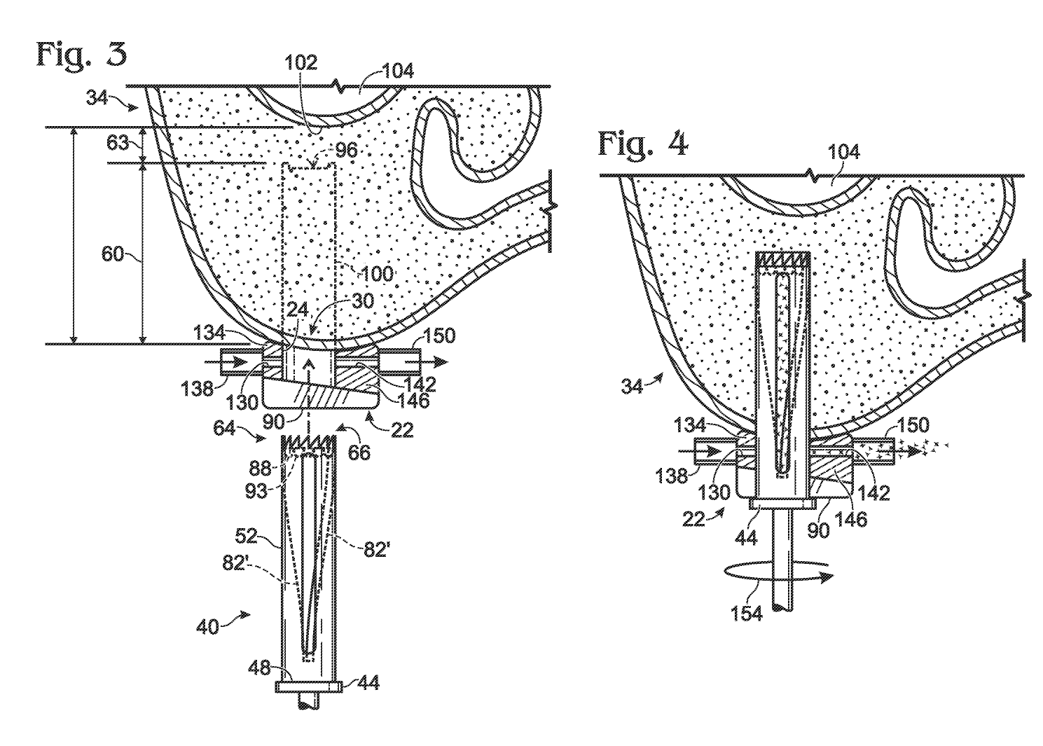

With reference to the examples shown in FIGS. 1 and 3, the first implant site portion 22 may comprise a first cylindrical aperture 24 that is located adjacent to an implant site 30 on the patient's maxillary jaw bone 34 when the surgical guide 10 is installed. Similarly, the second implant site portion 26 may comprise a second cylindrical aperture 28 that is located adjacent to another implant site on the patient's maxillary jaw bone 34. As explained in more detail below and with reference to FIG. 2, the first cylindrical aperture 24 of the first implant site portion 22 may have a first selected diameter 32 that corresponds to a first osteotomy drill 40. Similarly, and with reference to FIG. 1, the second cylindrical aperture 28 of the second implant site portion 26 may have a second selected diameter 36 that corresponds to a second osteotomy drill 42.

In one example, the first osteotomy drill 40 and second osteotomy drill 42 may be used with the surgical guide 10. With reference to FIGS. 1 and 3, the first osteotomy drill 40 may comprise a trephine drill having a first length 46 that corresponds to a first desired drilling depth 60 to be drilled into the maxillary jaw bone 34. The second osteotomy drill 42 may also comprise a trephine drill that has a second length 50 that is greater than the first length 46, and that corresponds to a second desired drilling depth having a greater length than the first desired drilling depth 60.

The first selected diameter 32 of the first cylindrical aperture 24 of the first implant site portion 22 may be greater than a first diameter 84 of the first osteotomy drill 40. In this manner, the first osteotomy drill 40 may be inserted into the first cylindrical aperture 24. Additionally, and as described in more detail below, the first selected diameter 32 of the first cylindrical aperture 24 of the first implant site portion 22 may be less than a second diameter 86 of the second osteotomy drill 42. Accordingly, the second osteotomy drill 42 may not be inserted into the first cylindrical aperture 24.

It will be appreciated that the first osteotomy drill 40 and/or the second osteotomy drill 42 may be attached to a dental handpiece that rotates the drill. It will also be appreciated that one or more additional osteotomy drills having lengths different from the first length 46 and the second length 50 may also be provided.

The first osteotomy drill 40 may include a stop ring 44 positioned between a cylindrical blade 52 and a shank 54 that extends from a proximal end 58 of the cylindrical blade. With reference to FIGS. 1 and 2, the first length 46 of the first osteotomy drill 40 may be the distance between a blade-side surface 48 of the stop ring 44 and the tips 62 of the cutting teeth 66. The stop ring 44 may also have a diameter that is wider than a distance between opposing walls 68, 70 on opposite sides of the first cylindrical aperture 24. In this manner, the first osteotomy drill 40 may be inserted into the first cylindrical aperture 24 until the blade-side surface 48 of the stop ring 44 contacts a first surface 90 adjacent to wall 68 and a second surface 94 adjacent to wall 70.

Similarly, the second osteotomy drill 42 may include a stop ring 72 positioned between a cylindrical blade 74 and a shank 76 that extends from a proximal end 78 of the cylindrical blade. The second length 50 of the second osteotomy drill 42 may be the distance between a blade-side surface 75 of the stop ring 72 and the tips 83 of the cutting teeth 80. The stop ring 72 may also have a diameter that is wider than the second selected diameter 36 of the second cylindrical aperture 28 at the second implant site portion 26. In this manner, the second osteotomy drill 42 may be inserted into the second cylindrical aperture 28 until the blade-side surface 75 of the stop ring 72 contacts a surface 29 that is adjacent to the second cylindrical aperture.

In one example, the first length 46 of the first osteotomy drill 40 may correspond to the first desired drilling depth 60. The implant site portion 22 may be formed to cooperate with the stop ring 44 of the first osteotomy drill 40 such that the drill may be inserted into the first cylindrical aperture 24 until the stop ring contacts first surface 90 and second surface 94 that are adjacent to the opposing walls 68, 70 of the implant site portion. The implant site portion 22 may be formed such that when the stop ring 44 contacts first surface 90 and second surface 94, the tips 62 of the cutting teeth 66 will have reached a bottom floor 96 of an implant hole 100 that corresponds to the first desired drilling depth 60. Additionally, and as described in more detail below, in one example the first osteotomy drill 40 may be configured to score a circular implant retention groove 160 at the bottom floor 96 of the implant hole 100. Advantageously, a dental professional may achieve the first desired drilling depth 60 by simply inserting the first osteotomy drill 40 into and through the first cylindrical aperture 24 until the stop ring 44 contacts the first surface 90 and second surface 94 of the implant site portion 22.

Additionally, the surgical guide 10 may be produced such that the first selected diameter 32 of the first cylindrical aperture 24 may be less than the second diameter 86 of the second osteotomy drill 42. In this manner, the second osteotomy drill 42, which is longer than the first osteotomy drill 40, may not be inserted into the first cylindrical aperture 24. Advantageously, in this example the surgical guide 10 may prevent a dental professional from using the second osteotomy drill 42 to drill at the first implant site 30, thereby precluding a possibility of using the second osteotomy drill to drill beyond the desired drilling depth 60 and potentially damaging a vital structure, such as the sinus cavity 104.

The above examples refer to utilizing the surgical guide 10 with osteotomy drills in the form of trephine drills. In other examples, at least some of the advantages of the surgical guide 10 may be realized using osteotomy drills having forms other than trephine drills, such as twist drills, for example.

As shown in FIG. 1, in one example a sleeve 110 may be seated within the first cylindrical aperture 24 of the first implant site portion 22. The sleeve 110 may fabricated from a metal, such as aluminum, and may have a sleeve diameter 114 that is greater than the first diameter 84 of the first osteotomy drill 40. The sleeve diameter 114 may also be less than the second diameter 86 of the second osteotomy drill 42. In this manner, the sleeve 110 may guide the insertion of the first osteotomy drill 40 through the first cylindrical aperture 24. The sleeve 110 may also protect the surface of the first cylindrical aperture from direct contact with the rotating cylindrical blade 52. It will be appreciated that for purposes of illustration and description, a sleeve is not shown in FIGS. 2-6.

In another example, a guide cylinder 118 may be removably received in the second cylindrical aperture 28 at the second implant site portion 26. The guide cylinder 118 may also fabricated from a metal, such as aluminum, and may include a handle 122 that extends from an upper surface of the guide cylinder to facilitate insertion into and removal from the second cylindrical aperture 28. The guide cylinder 118 may have an inner guide cylinder diameter 126 that is greater than the second diameter 86 of the second osteotomy drill 42. In this manner, the guide cylinder 118 may guide the insertion of the second osteotomy drill 42 through the second cylindrical aperture 28. It will also be appreciated that a guide cylinder may be utilized instead of a sleeve in conjunction with the first cylindrical aperture 24, and a sleeve may be utilized instead of a guide cylinder in conjunction with the second cylindrical aperture 28.

With reference now to FIGS. 1-4, the surgical guide 10 may include a fluid delivery passage 130 that extends through a first wall 134 of the first implant site portion 22. Fluid supply tubing 138 may be connected to a fluid supply source (not shown) and to the fluid delivery passage 130 to supply irrigation fluid, such as water or saline, directly to the first implant site 30 and first osteotomy drill 40 as the implant hole 100 is drilled. In one example, irrigation fluid may be supplied directly to the first implant site 30 and the first osteotomy drill 40 in a substantially continuously flowing manner whenever the drill is drilling into bone. Advantageously, such direct and consistent supply of irrigation fluid effectively cools the first osteotomy drill 40 and enables the drill to operate while inhibiting thermal bone necrosis within the implant hole 100. Accordingly, such direct and consistent supply of irrigation fluid may enable drilling of the entire implant hole 100 in a single insertion of the drill, without stopping or removing the drill prior to completion of the implant hole. Additionally, the integrated delivery of irrigation fluid by the fluid delivery passage 130 may eliminate the need for a separate, manually operated irrigation instrument operated by an assistant.

The surgical guide 10 may also include a fluid collection passage 142 that is configured to evacuate irrigation fluid from the first implant site 30 and implant hole 100. The fluid collection passage 142 may extend through a second wall 146 of the first implant site portion 22 that is located opposite to the first wall 134. Vacuum tubing 150 may be connected to a vacuum source (not shown) and to the fluid collection passage 142 to continuously evacuate irrigation fluid and bone debris from the first implant site 30 and implant hole 100 during the drilling procedure. Advantageously, the fluid collection passage 142 may continuously evacuate fluid and debris during the drilling procedure to facilitate prompt and efficient removal of such fluid and debris. Further, the integrated evacuation of irrigation fluid and debris by the fluid collection passage 142 may eliminate the need for a separate, manually operated vacuum instrument operated by an assistant.

With reference now to FIGS. 3-6, one example of a dental implant method according to the present disclosure will now be provided. As shown in FIGS. 3 and 4, the first osteotomy drill 40 may be inserted into and through the first cylindrical aperture 24 of the first implant site portion 22 at the first implant site 30. As noted above, in one example the first osteotomy drill 40 may comprise a trephine drill that includes a cylindrical blade 52 and a shank 54 that extends from a proximal end 58 of the cylindrical blade. A plurality of cutting teeth 66 having tips 62 may be located at a distal end 64 of the cylindrical blade 52.

In another example, and with reference now to FIG. 11, the first osteotomy drill 40 may include an internal blade 82 within an internal diameter of the cylindrical blade 52. The internal blade 82 includes a first leading edge 88 that is adjacent to the distal end 64 of the cylindrical blade 52, and is spaced axially from the tips 62 of the cutting teeth 66. A first connecting surface 89 may extend from the first leading edge 88 to a first trailing edge 91. The first connecting surface 89 may slope downwardly from the first leading edge 88 with respect to a plane through the first leading edge that is perpendicular to a longitudinal axis 98 of the cylindrical blade 52. A first leading surface below the first leading edge 88 may include one or more scalloped portions 93 that cooperate with the first leading edge 88 to remove bone and/or gingiva as the first osteotomy drill 40 is rotated and pressed into bone and/or gingiva.

The internal blade 82 includes a second leading edge 92 that is spaced radially from the first leading edge 88 and is similarly spaced axially from the tips 62 of the cutting teeth 66. A second connecting surface 95 may extend from the second leading edge 92 to a second trailing edge 97. The second connecting surface 95 may slope downwardly from the second leading edge 92 with respect to a plane through the second leading edge that is perpendicular to a longitudinal axis 98 of the cylindrical blade 52. A second leading surface below the second leading edge 92 may include one or more scalloped portions 99 that cooperate with the second leading edge 92 to remove bone and/or gingiva as the first osteotomy drill 40 is rotated and pressed into bone and/or gingiva.

With reference also to FIGS. 3 and 4, as the first osteotomy drill 40 is rotated in the direction of action arrow 154 and advanced into bone material of the jaw bone 34, the cutting teeth 66 score a circular groove into the bone. As the first osteotomy drill 40 advances, the first leading edge 88 and second leading edge 92 of the internal blade 82 contact and scrape away bone material from within the circular groove. Additionally, and as shown in FIG. 11, in one example the internal blade 82 extends helically from the distal end 64 of the cylindrical blade 52 toward the proximal end 58 of the cylindrical blade, as indicated by broken lines 82′. Advantageously, this helical configuration may enable the internal blade 82 to funnel bone material toward the proximal end 58 of the cylindrical blade 52 and away from the first leading edge 88 and second leading edge 92. In this manner, undesirable collections of bone material near the first leading edge 88 and second leading edge 92 during the drilling procedure may be avoided. With reference to FIG. 4, such bone material is illustrated as visible through the longitudinal slot in the cylindrical blade 52, and is shown exiting the fluid collection passage 142.

In other examples, osteotomy drills having multiple internal blades and/or leading edges may be provided. In one example and with reference to FIG. 12, an osteotomy drill 40′ may include a first internal blade 210, second internal blade 230 and third internal blade 250 within a diameter of the cylindrical blade 52′. The first internal blade 210 includes a first leading edge 214 that is adjacent to the distal end 64′ of the cylindrical blade 52′, and is spaced axially from the tips 62′ of the cutting teeth 66′. A first connecting surface 216 may extend from the first leading edge 214 to a first trailing edge 218. The first connecting surface 216 may slope downwardly from the first leading edge 214 with respect to a plane through the first leading edge that is perpendicular to a longitudinal axis of the cylindrical blade 52′. A first leading surface below the first leading edge 214 may include one or more scalloped portions 220 that cooperate with the first leading edge 214 to remove bone and/or gingiva as the osteotomy drill 40′ is rotated and pressed into bone and/or gingiva.

The second internal blade 230 includes a second leading edge 234 that is adjacent to the distal end 64′ of the cylindrical blade 52′, and spaced axially from the tips 62′ of the cutting teeth 66′. A second connecting surface 236 may extend from the second leading edge 234 to a second trailing edge 238. The second connecting surface 236 may slope downwardly from the second leading edge 234 with respect to a plane through the first leading edge that is perpendicular to a longitudinal axis of the cylindrical blade 52′. A second leading surface below the second leading edge 234 may include one or more scalloped portions 240 that cooperate with the second leading edge to remove bone and/or gingiva as the osteotomy drill 40′ is rotated and pressed into bone and/or gingiva.

The third internal blade 250 includes a third leading edge 254 that is adjacent to the distal end 64′ of the cylindrical blade 52′, and is axially spaced from the tips 62′ of the cutting teeth 66′. A third connecting surface 256 may extend from the third leading edge 254 to a third trailing edge 258. The third connecting surface 256 may slope downwardly from the third leading edge 254 with respect to a plane through the third leading edge that is perpendicular to a longitudinal axis of the cylindrical blade 52′. A third leading surface below the third leading edge 254 may include one or more scalloped portions 260 that cooperate with the third leading edge to remove bone and/or gingiva as the osteotomy drill 40′ is rotated and pressed into bone and/or gingival. It will also be appreciated that other configurations of osteotomy drills having multiple internal blades may also be provided.

As shown in FIGS. 3 and 4, in one example the implant site portion 22 of the surgical guide 10 may be designed to be used with the first osteotomy drill 40. The cylindrical blade 52 of the first osteotomy drill 40 may be inserted through the first cylindrical aperture 24 of the implant site portion 22 until the stop ring 44 contacts a first surface 90 of the implant site portion. As noted above, in one example the implant site portion 22 may be formed such that when the stop ring 44 contacts the first surface 90, the tips 62 of the cutting teeth 66 will have reached the bottom floor 96 of the implant hole 100, which may correspond to the first desired drilling depth 60. Alternatively expressed, the maximum insertion position of the first osteotomy drill 40 (shown in FIG. 4) may correspond to the first desired drilling depth 60. In another example and as described in more detail below, at the maximum insertion position the cutting teeth 66 may also score a circular implant retention groove at the bottom floor 96 of the implant hole 100. Advantageously, a safety margin 63 may be maintained between the bottom floor 96 of the implant hole 100 and a periphery 102 of the sinus cavity 104.

As explained above, the first osteotomy drill 40 including at least one internal blade may operate to contact and scrape away gingiva and/or bone as the drill is rotated and pressed into gingiva and/or bone. Advantageously, when drilling into bone this configuration may enable an entire implant hole to be drilled in one process, and without stopping or removing the drill 40 from the implant hole prior to the hole being completed. Accordingly, this configuration may enable the step of drilling an implant hole, such as implant hole 100, to be performed using only one osteotomy drill 40, and without drilling a pilot hole or other intermediate holes prior to drilling the complete implant hole.

Additionally, and as shown in FIG. 4, when the first osteotomy drill 40 is used in conjunction with the surgical guide 10, the implant site portion 22 of the guide may supply irrigating fluid through fluid delivery passage 130 directly to the implant site 30 and the osteotomy drill during the drilling procedure. Advantageously, such direct and continuous supply of irrigation fluid effectively cools the first osteotomy drill 40 to inhibit or substantially eliminate thermal bone necrosis within the implant hole 100 during drilling. Accordingly, a dental professional may drill the implant hole 100 in one drilling step using only one osteotomy drill 40.

Also as shown in FIG. 4, the fluid collection passage 142 of the surgical guide 10 is configured to evacuate irrigation fluid and bone debris from the first implant site 30 and implant hole 100. Advantageously, the fluid collection passage 142 may continuously evacuate fluid and debris during the drilling procedure to facilitate prompt and efficient removal of such fluid and debris.

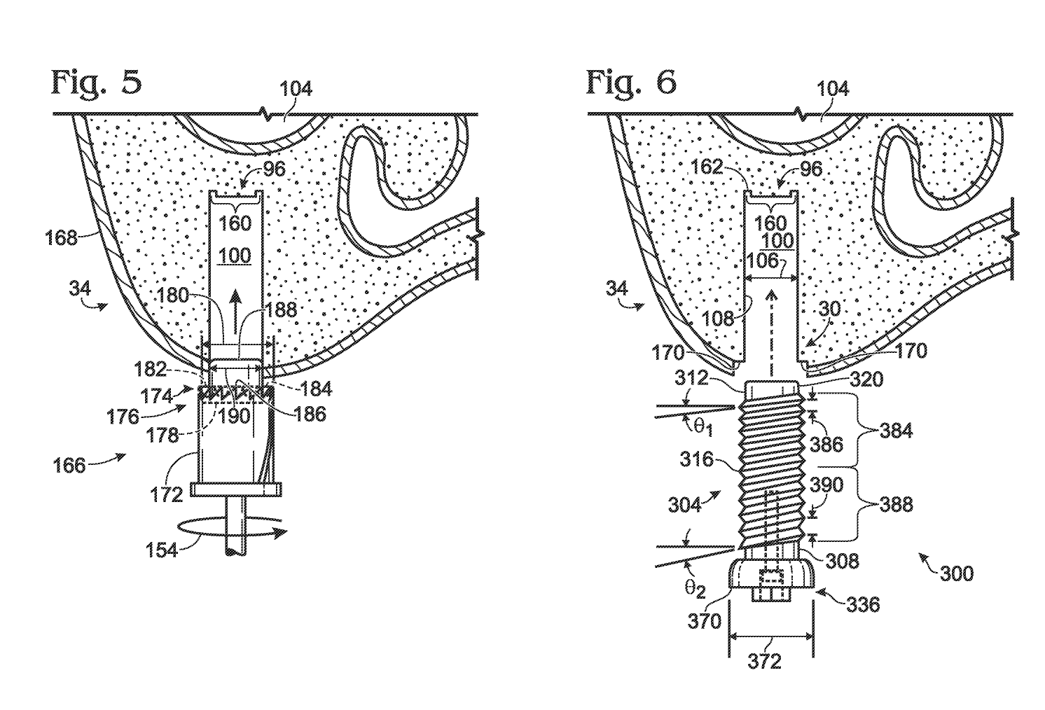

As noted above, as the first osteotomy drill 40 is rotated in the direction of action arrow 154 and advanced into bone material of the maxillary jaw bone 34, the cutting teeth 66 score a circular groove into the bone. With reference also to FIG. 5 and as explained in more detail below, the first osteotomy drill 40 may create a circular implant retention groove 160 at the bottom floor 96 of the implant hole 100.

Also as shown in FIGS. 5 and 6, a site preparation trephine drill 166 may be utilized to remove gingiva 168 adjacent to the implant hole 100 to create a ledge portion 170 in the bone surface surrounding the implant hole 100. The site preparation trephine drill 166 may include a first cylindrical blade 172 having a plurality of cutting teeth 174 with tips 186 at a distal end 176 of the first cylindrical blade. Similar to the first osteotomy drill 40 described above and shown in FIG. 11, the site preparation trephine drill 166 may include an internal blade 178 within a first diameter 180 of the first cylindrical blade 172.

The internal blade 178 may include a first leading edge 182 and a second leading edge 184 that may be shaped and oriented in a manner similar to the first leading edge 88 and second leading edge 92 of the first osteotomy drill 40 shown in FIG. 11. However, the first leading edge 182 and second leading edge 184 are flush with the cutting plane of the tips 186 of the cutting teeth 174, as opposed to being spaced axially from the tips of the cutting teeth as in the first osteotomy drill 40. Accordingly, as the site preparation trephine drill 166 is advanced into contact with the gingiva 168 adjacent to the implant hole 100, the tips 186 of the cutting teeth 174 and the first leading edge 182 and second leading edge 184 of the internal blade 178 may engage the gingiva substantially simultaneously to scrape away and remove the gingiva adjacent to the implant hole. In this manner, the site preparation trephine drill may create the ledge portion 170 in the bone surface surrounding the implant hole 100.

The site preparation trephine drill 166 may also include a second cylindrical blade 188 that is oriented within and coaxially with the first cylindrical blade 172. The second cylindrical blade 188 may extend axially beyond the tips 186 of the cutting teeth 174 of the first cylindrical blade 172. As shown in FIG. 5, the second cylindrical blade 188 may have a second diameter 190 that is less than the first diameter 180 of the first cylindrical blade 172. The second diameter 190 may also be slightly less than the diameter 106 of the implant hole 100, such that the second cylindrical blade 188 may be inserted into the implant hole. In this manner, the second cylindrical blade 188 may be operable to center the cutting teeth 174 over the implant hole 100 and to guide the cutting teeth and internal blade 178 to remove gingiva 168 adjacent to the implant hole.

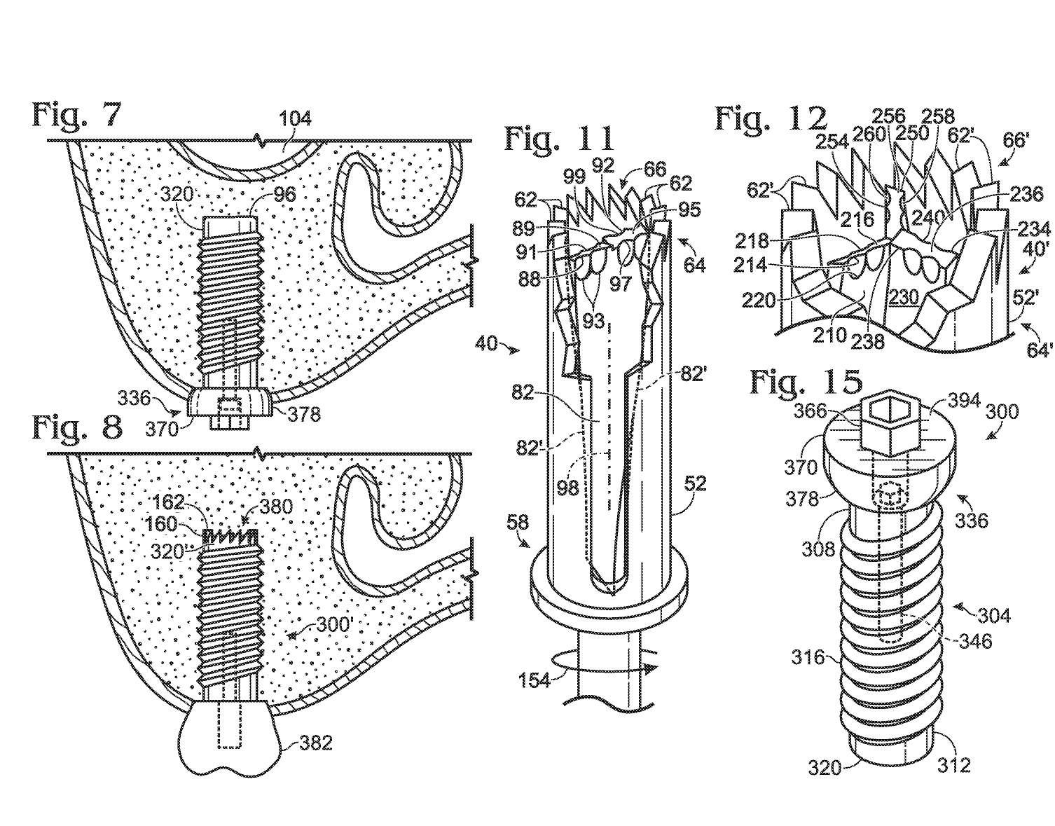

With reference now to FIG. 6, a dental implant 300 may be inserted into the implant hole 100. In one example, the dental implant 300 may include an implant shaft 304 that extends between a proximal end 308 and a distal end 312 of the dental implant. The dental implant 300 includes a thread 316 wrapping in a helical fashion around the implant shaft 304 between the proximal end 308 and the distal end 312. At the distal end 312 of the dental implant 300, a circular lip 320 extends axially and is configured to seat into the circular implant retention groove 160 at the bottom floor 96 of the predrilled implant hole 100, as also illustrated in FIG. 7.

As explained in more detail below, the circular lip 320 seated in the implant retention groove 160 provides enhanced initial stability and apical retention of the dental implant 300 within the implant hole 100, thereby promoting improved osseointegration of the implant and reduced healing time. In one example as shown in FIGS. 6 and 14, the circular lip 320 may comprise an annular surface 322 that is configured to seat into the circular implant retention groove 160. The annular surface 322 may have a thickness 324 that corresponds to a width of the circular implant retention groove 160, such that the annular surface seats into the circular implant retention groove with an interference fit. In this manner, both the internal wall 326 and the external wall 328 of the annular surface 322 are in contact with bone surface that defines the circular implant retention groove 160. Advantageously, the surface area contact between the internal wall 326, the external wall 328 and the bone surface defining the circular implant retention groove 160 may improve osseointegration and provide enhanced stability to the dental implant 300. Additionally, a top surface 330 of the annular surface 322 may be in contact with bone surface at a distal end 162 of the circular implant retention groove 160, providing still further stability enhancement to the dental implant 300.

The annular surface 322 may also have a height 332 that corresponds to a height of the circular implant retention groove 160, such that a planar end portion 334 of the dental implant 300 may be in contact with bone surface at the bottom floor 96 of the implant hole 100 when the annular surface 322 of the circular lip 320 is seated in the circular implant retention groove. In this manner, the surface area of the planar end portion 334 in contact with bone surface at the bottom floor 96 of the implant hole 100 may also provide additional stability to the dental implant 300.

With reference now to FIG. 8, in another example a circular lip 320′ of a dental implant 300′ may comprise a plurality of serrated edges 380 that are configured to seat into the circular implant retention groove 160 and to embed into additional bone at the distal end 162 of the circular implant retention groove. In one example, the length of the dental implant 300′ and the desired drilling depth 60 of the implant hole 100 may be coordinated such that the serrated edges 380 of the circular lip 320′ may embed into additional bone at a distal end 162 of the circular implant retention groove 160 when the dental implant is driven into the implant hole 100. Advantageously, the serrated edges 380 may grip the additional bone into which they are embedded to provide additional stability to the dental implant 300′ during the healing phase and subsequent useful life of the implant. In this manner, the serrated edges 380 may improve osseointegration and may reduce healing time. In one example, a dental implant 300′ having serrated edges 380 may be utilized when the implant hole 100 is adequately spaced from vital structures to ensure that the serrated edges will not contact such vital structures. In other examples, and as illustrated in FIG. 8, once the dental implant 300′ has been inserted and seated within the implant hole 100, a prosthetic tooth or crown 382 may be affixed to the implant.

With reference again to FIG. 6, in one example the thread 316 of the dental implant 300 may comprise a self-tapping thread that includes a first portion 384 adjacent to the distal end 312 of the implant and a second portion 388 adjacent to the proximal end 308 of the implant. The first portion 384 of the thread 316 may have a first pitch 386, and the second portion 388 of the thread may have a second pitch 390 that is greater than the first pitch. As the dental implant 300 is driven into the implant hole 100, the first portion 384 of thread 316 will engage bone in the surrounding wall 108 of the implant hole. Advantageously, as the dental implant 300 advances and the second portion 388 of thread 316 begins engaging bone in the surrounding wall 108, the second portion will engage at least a portion of previously untapped bone, and will not follow the female thread already tapped by the first portion 384. In this manner, the asymmetrical pitches of the first portion 384 and the second portion 388 of the thread 316 may provide improved retention of the dental implant 300 within the implant hole 100. It will be appreciated that in other examples, the second portion 388 may be adjacent to the distal end 312 of the implant and the first portion 384 may be between the second portion 388 and the proximal end 308 of the implant.

With continued reference to FIG. 6, the second portion 388 of thread 316 may be angled more aggressively than the first portion 384 to improve retention of the dental implant 300 within the implant hole 100. In one example shown in FIG. 6, the first portion 384 may have a first helix angle θ₁ and the second portion 388 may have a second helix angle θ₂ that is greater than the first helix angle θ₁. In this manner, the second portion 388 of the thread 316 may engage bone in the surrounding wall 108 of the implant hole 100 at a differing and more aggressive angle than the first portion 384, thereby improving implant retention of the dental implant 300 within the implant hole.

As shown in FIGS. 6 and 7, and with reference also to FIGS. 14 and 15, in one example the dental implant 300 may be removably coupled to a healing abutment 336 at the proximal end 308 of the implant. The healing abutment 336 may include an abutment driver shaft 338 that is configured to be received in a corresponding implant shaft socket 340 in the shaft 304 of the dental implant 300. The implant shaft socket 340 may be located adjacent to the proximal end 308 of the dental implant 300. The healing abutment 336 may also include a healing abutment socket 366 located on an opposing end of the healing abutment from the abutment driver shaft 338. A threaded fastener 342 may extend through an aperture 344 in the healing abutment socket 366, through the abutment driver shaft 338, and through the corresponding implant shaft socket 340 of the dental implant 300 to engage a threaded shaft 346 in the implant shaft 304. A chamfered neck 350 of the threaded fastener 342 may seat against a corresponding conical surface 354 in the healing abutment 336 to removably fasten the healing abutment to the dental implant 300.

A threaded fastener driver such as a first hex key (not shown) may be inserted into a matching threaded fastener socket 358 and rotated to drive the threaded fastener 342 into the threaded shaft 346. With the healing abutment 336 fastened to the dental implant 300, an implant driver such as a second hex key 362 may be inserted into the matching healing abutment socket 366. With reference to FIGS. 6 and 7, the second hex key 362 may be rotated as the dental implant 300 is pressed into the implant hole 100 to engage the self-tapping thread 316 of the implant with the surrounding wall 108 of the implant hole. The dental implant 300 may be rotated and urged into the implant hole 100 until the circular lip 320 of the implant is seated within the circular implant retention groove 160 at the bottom floor 96 of the implant hole.

With reference again to FIGS. 6, 7, 14 and 15, the healing abutment 336 may include a projection 370 having a projection diameter 372 that is greater than the implant hole diameter 106. A first surface 374 of the projection 370 may extend radially from a central axis 376 of the healing abutment 336. A rounded landing surface 378 may extend from the first surface 374 toward the healing abutment socket 366 to a second surface 394. In this manner, as dental implant 300 is driven into the implant hole 100, the landing surface 378 of the projection 370 is configured to stop advancement of the dental implant via contact between the landing surface and the ledge portion 170 of bone surrounding the implant hole 100. Advantageously, the projection 370 may thereby prevent the dental implant 300 from being driven beyond a desired drilling depth, such as desired drilling depth 60, within the implant hole 100.

In one example situation, where insufficient bone is available to anchor a dental implant, bone graft material may be placed within the sinus cavity to provide supplemental anchoring for the implant. In these situations, the projection 370 of the healing abutment 336 may prevent the dental implant 300 from being advanced further than the desired depth into the sinus cavity, which could result in potentially losing the implant in the cavity.

In another example, the length of the dental implant 300 and the desired drilling depth 60 of the implant hole 100 may be coordinated such that the projection 370 of the healing abutment 336 provides a nominal compressive force against the ledge portion 170 surrounding the implant hole 100 when the circular lip 320 of the dental implant is seated within the implant retention groove 160. Advantageously, such nominal compressive force may facilitate osseointegration and may shorten the healing process.

It will also be appreciated that the healing abutment 336 and projection 370 may stabilize and protect the dental implant 300 after insertion and during the healing process. Advantageously, such supplemental stabilization may also facilitate osseointegration and shorten the healing process. In one example, the healing abutment 336 and projection 370 may prevent unwanted movement and/or advancement of the implant into the implant hole 100 during the healing process, which may otherwise occur upon inadvertent contact with or loading of the implant. In other examples where the dental implant 300 may be subject to significant axial loading in the direction of the implant hole 100, the healing abutment 336 and projection 370 may prevent the implant from traveling through the bottom floor 96 of the implant hole 100 and potentially into a vital structure, such as the sinus cavity 104.

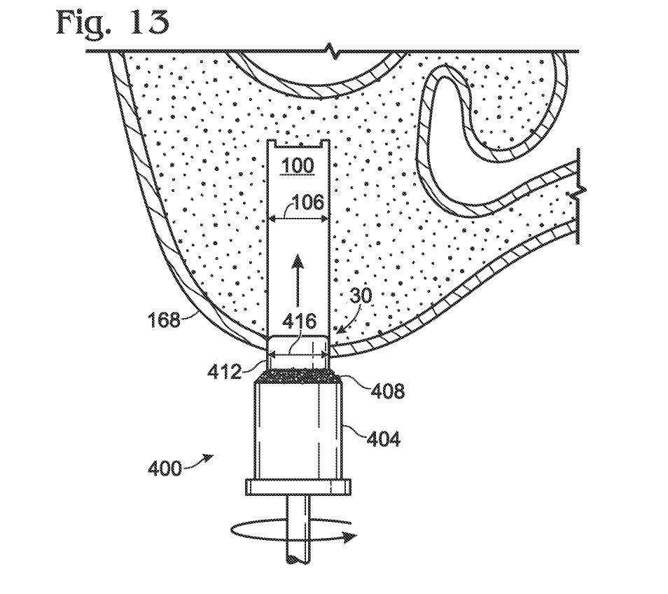

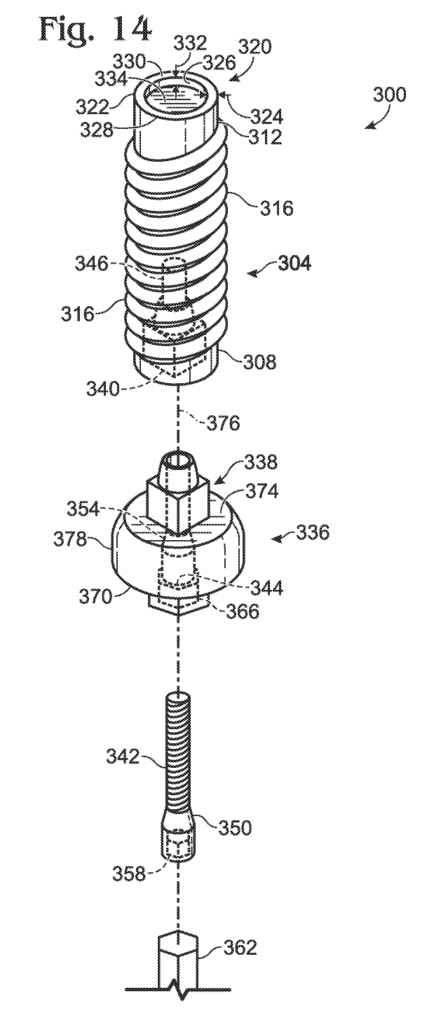

With reference now to FIG. 13, in another example a gingiva contouring drill 400 may be utilized to contour gingiva 168 adjacent to the implant site 30. The gingiva contouring drill 400 may comprise a cylindrical body 404 and a contouring surface 408 that is angled inwardly toward an axis of rotation of the contouring drill. In one example, the contouring surface 408 may comprise particles of an abrasive material, such as diamond crystals, and may be angled at approximately 45 degrees with respect to the axis of rotation of the gingiva contouring drill 400.

The gingiva contouring drill 400 may include a centering ring 412 having a diameter 416 that corresponds to the diameter 106 of the implant hole 100. In this manner, the centering ring 412 may be inserted into the implant hole 100 to center and guide the gingiva contouring drill as it is advanced toward the implant site 30. Advantageously, the gingiva contouring drill 400 may be advanced into the implant hole 100 such that the contouring surface 408 removes gingiva 168 adjacent to the implant site 30. The centering ring 412 may enable the dental professional to easily advance and retract the drill while maintaining centered alignment with the implant hole 100. Accordingly, the gingiva contouring drill 400 may create an angled emergence profile in the gingiva 168 adjacent to the implant site 30 that may match the contour of a healing abutment, such as the healing abutment 336 shown in FIG. 7, or the contour of a prosthetic tooth or crown, such as the prosthetic tooth 382 shown in FIG. 8.

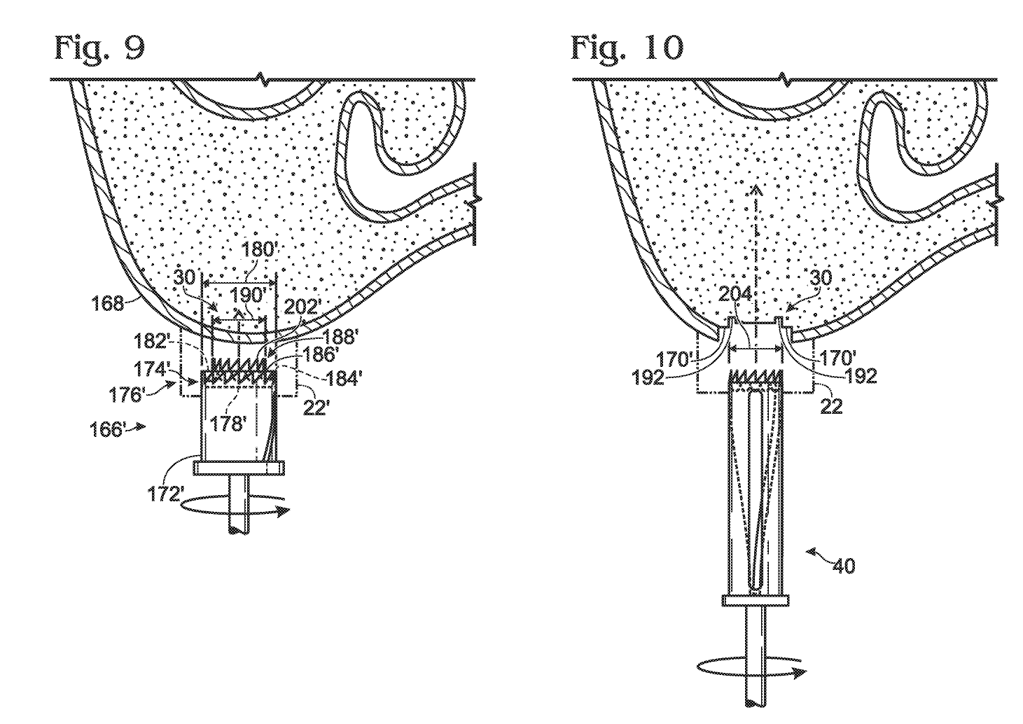

With reference now to FIGS. 9 and 10, in another example a site preparation trephine drill 166′ may be utilized to remove gingiva 168 adjacent to an implant site 30 prior to an implant hole being drilled. The site preparation trephine drill 166′ may create a ledge portion 170′ in the bone surface surrounding the implant hole to be drilled, and a circular drilling guide groove 192 for guiding the drilling of the implant hole. Similar to the site preparation trephine drill 166 described above and shown in FIG. 5, the site preparation trephine drill 166′ may include a first cylindrical blade 172′ having a plurality of cutting teeth 174′ with tips 186′ at a distal end 176′ of the first cylindrical blade. Like the site preparation trephine drill 166, the site preparation trephine drill 166′ may include an internal blade 178′ within a first diameter 180′ of the first cylindrical blade 172′. The internal blade 178′ may include a first leading edge 182′ and a second leading edge 184′ that are shaped and oriented in a manner similar to the first leading edge 88 and second leading edge 92 of the first osteotomy drill 40 shown in FIG. 11. However, the first leading edge 182′ and second leading edge 184′ are not spaced from the tips 186′ of the cutting teeth 174′, but are flush with the cutting plane of the tips of the cutting teeth. In this manner, as the site preparation trephine drill 166′ is advanced into contact with the gingiva 168, the tips 186′ of the cutting teeth 174′ and the first leading edge 182′ and second leading edge 184′ of the internal blade 178′ may engage the gingiva substantially simultaneously to scrape away and remove the gingiva adjacent to the implant hole 100.

The site preparation trephine drill 166′ may also include a second cylindrical blade 188′ that is oriented within and coaxially with the first cylindrical blade 172′. The second cylindrical blade 188′ may include cutting teeth 202′ that extend axially beyond the tips 186′ of the cutting teeth 174′ of the first cylindrical blade 172′. As shown in FIG. 9, the second cylindrical blade 188′ may have a second diameter 190′ that is less than the first diameter 180′ of the first cylindrical blade 172′. The second diameter 190′ may also be selected to match a diameter of an implant hole to be drilled, such as the diameter 106 of the implant hole 100 shown in FIG. 6. Accordingly, the second diameter 190′ may be substantially equivalent to the osteotomy drill diameter 84 of the first osteotomy drill 40.

With reference to FIG. 9, it will be appreciated that the site preparation trephine drill 166′ may be utilized with a surgical guide and a corresponding implant site portion, such as an implant site portion 22′, to guide the site preparation trephine drill in preparing the implant site 30 as describe below. In other examples, the site preparation trephine drill 166′ may be utilized without a surgical guide. In one example as shown in FIGS. 9 and 10, the site preparation trephine drill 166′ may be advanced toward the implant site 30 such that the cutting teeth 202′ engage and cut a circular groove through the gingiva 168. As the site preparation trephine drill 166′ continues to advance, the cutting teeth 202′ begin to score the circular drilling guide groove 192 in the bone surface at the implant site 30. Additionally, as the site preparation trephine drill 166′ continues to advance, the internal cutting teeth 174′ of the first cylindrical blade 172′ and the internal blade 178′ remove additional gingiva 168 adjacent to the implant site 30 across a length of the internal blade, and create the ledge portion 170′ in the bone surface surrounding the implant hole to be drilled.

Advantageously, and with reference to FIG. 10, a dental professional may insert the cutting teeth 66 of the first osteotomy drill 40 into the circular drilling guide groove 192 to guide the initial placement of the cutting teeth and position the drill to form the desired implant hole 100. It will be appreciated that in some examples a gingiva contouring drill, such as gingiva contouring drill 400, may be utilized to contour gingiva 168 adjacent to the implant site 30 either prior to drilling the implant hole 100 with the first osteotomy drill 40 or after drilling the implant hole. A dental implant, such as dental implant 300, may be placed in the implant hole 100 as described above.

Another embodiment of the present disclosure relates to a surgical guide system that may include the surgical guide 10 described above and illustrated in FIGS. 1-4. As explained above, the surgical guide system may ensure that a desired drilling depth into a jaw bone is not exceeded. In some examples, aspects and components of the surgical guide system, such as the first selected diameter 32 of the first cylindrical aperture 24 of the surgical guide 10, may correspond to aspects and components of one or more osteotomy drills, such as the first diameter 84 and/or the first length 46 of the first osteotomy drill 40, to enable a dental professional to achieve a desired drilling depth as described above. In other examples, aspects and components of the surgical guide system, such as the selected diameters of two or more cylindrical apertures in the surgical guide 10, may correspond to aspects and components of two or more osteotomy drills, such diameters and/or lengths of the drills, to prevent a dental professional from using an osteotomy drill having a length that could result in a drilling depth that exceeds a desired drilling depth. Also as described above, the surgical guide system may include one or more fluid delivery passages, one or more fluid collection passages, one or more sleeves and/or one or more guide cylinders.

Another embodiment of the present disclosure relates to a dental implant preparation system that may include a trephine drill such as the first osteotomy trephine drill 40 described above and shown in FIGS. 1-4 and 11. The dental implant preparation system may include other examples of trephine drills, such as the osteotomy trephine drill 40′ described above and shown in FIG. 12. The dental implant preparation system may also include a site preparation drill such as the site preparation trephine drill 166 described above and shown in FIG. 5, and/or the site preparation trephine drill 166′ described above and shown in FIG. 9.

Another embodiment of the present disclosure relates to a dental implant system that may be used in performing the methods described above. In one example the dental implant system may include a dental implant such as the dental implant 300 described above and shown in FIGS. 6, 7, 14 and 15. In another example the dental implant system may include a dental implant such as the dental implant 300′ described above and shown in FIG. 8. The dental implant system may also include a healing abutment, such as healing abutment 336, that is removably coupled to a dental implant.

It will be appreciated that in some examples the surgical guide system, dental implant preparation system, dental implant system and their various components described above and illustrated in FIGS. 1-15 may be utilized together as a unified system and/or in various combinations for preparing an implant site for a dental implant and placing the implant within an implant hole. It will also be understood that the configurations and/or approaches described herein are exemplary in nature, and that these specific embodiments or examples are not to be considered in a limiting sense, because numerous variations are possible. For example, while the examples described above refer to implant procedures involving the maxillary jaw bone of a patient, the methods, systems and related devices described herein may also be utilized for dental implant procedures involving the mandibular jaw bone of a patient.

The specific routines or methods described herein may represent one or more of any number of strategies for preparing an implant site for a dental implant and placing the implant within an implant hole according to the present disclosure. As such, various steps described and illustrated may be performed in the sequence and illustrated, in other sequences, in parallel, or in some cases omitted. Likewise, the order of the above-described steps may be changed.

It will also be appreciated that references to “one embodiment” or “an embodiment” are not intended to be interpreted as excluding the existence of additional embodiments that also incorporate the recited features. Unless explicitly stated to the contrary, embodiments “comprising,” “including,” or “having” an element or a plurality of elements having a particular property may include additional such elements not having that property. The terms “including” and “in which” are used as the plain-language equivalents of the respective terms “comprising” and “wherein.” Moreover, the terms “first,” “second,” and “third,” etc. are used merely as labels, and are not intended to impose numerical requirements or a particular positional order on their objects. The term “adjacent” is used to mean that a first element or structure is nearby or in close proximity to a second element or structure, and includes the first and second elements or structures being in contact and not in contact.

The following claims particularly point out certain combinations and sub-combinations regarded as novel and non-obvious. These claims may refer to “an” element or “a first” element or the equivalent thereof. Such claims should be understood to include incorporation of one or more such elements, neither requiring nor excluding two or more such elements. Other combinations and sub-combinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

1. A dental implant method, comprising:
drilling an implant hole having an implant hole diameter into a jaw bone at an implant site;
removing gingiva adjacent to the implant hole to create a ledge portion in a bone surface surrounding the implant hole; and
inserting into the implant hole a dental implant having a healing abutment that is removably coupled to a proximal end of the dental implant, wherein the healing abutment includes a projection having a projection diameter that is greater than the implant hole diameter, such that as the dental implant is driven into the implant hole, the projection is configured to stop advancement of the dental implant via contact between the projection and the ledge portion.

2. The dental implant method of claim 1, wherein the step of removing gingiva adjacent to the implant hole is performed using a site preparation trephine drill.

3. The dental implant method of claim 2, wherein the step of removing gingiva adjacent to the implant hole is performed by at least one internal blade of the site preparation trephine drill.

4. The dental implant method of claim 1, wherein the step of drilling an implant hole is performed using only one osteotomy trephine drill comprising a cylindrical blade that includes a plurality of cutting teeth at a distal end of the cylindrical blade and at least one internal blade.

5. The dental implant method of claim 4, further comprising inserting the plurality of cutting teeth of the osteotomy trephine drill into a circular drilling guide groove in the bone surface at the implant site.

6. The dental implant method of claim 4, further comprising:
inserting the cylindrical blade of the osteotomy trephine drill through an aperture in a surgical guide to guide the drilling of the implant hole; and
supplying fluid through a fluid delivery passage in the surgical guide to the osteotomy trephine drill, such that thermal bone necrosis within the implant hole is inhibited.

7. The dental implant method of claim 6, further comprising evacuating fluid from the implant hole through a fluid collection passage in the surgical guide.

8. The dental implant method of claim 1, wherein the healing abutment comprises an abutment socket, further comprising:
inserting an implant driver into the abutment socket of the healing abutment; and
rotating the implant driver to drive the dental implant into the implant hole.

9. The dental implant method of claim 1, wherein the projection extends radially from a central axis of the healing abutment.

10. A dental implant method, comprising:
drilling an implant hole into a jaw bone;
scoring a circular implant retention groove at a bottom floor of the implant hole;
inserting into the implant hole a dental implant, the dental implant including a circular lip extending axially from a distal end of the dental implant; and
seating the circular lip of the dental implant into the circular implant retention groove at the bottom floor of the implant hole.

11. The dental implant method of claim 10, wherein the steps of drilling an implant hole and scoring a circular implant retention groove are performed using only one osteotomy trephine drill comprising a cylindrical blade that includes a plurality of cutting teeth at a distal end of the cylindrical blade.

12. The dental implant method of claim 11, wherein the osteotomy trephine drill includes at least one internal blade that is operable to remove bone material as the osteotomy trephine drill is rotated and pressed into the jaw bone.

13. The dental implant method of claim 12, further comprising:
inserting the osteotomy trephine drill through an aperture in a surgical guide to guide the drilling of the implant hole; and
supplying fluid through a fluid delivery passage in the surgical guide to the osteotomy trephine drill, such that thermal bone necrosis within the implant hole is inhibited.

14. The dental implant method of claim 13, further comprising evacuating the fluid and bone material from the implant hole through a fluid collection passage in the surgical guide.

15. The dental implant method of claim 12, wherein a leading edge of the at least one internal blade is spaced from tips of the cutting teeth, and wherein the step of scoring a circular implant retention groove at a bottom floor of the implant hole is performed by the cutting teeth as the osteotomy trephine drill is rotated and pressed into the jaw bone.

16. The dental implant method of claim 12, wherein the at least one internal blade extends helically toward a proximal end of the cylindrical blade.

17. The dental implant method of claim 12, wherein a distal portion of the at least one internal blade is angled with respect to a plane perpendicular to a longitudinal axis of the cylindrical blade.

18. The dental implant method of claim 10, wherein the circular lip of the dental implant comprises an annular surface that is configured to seat into the circular implant retention groove.

19. The dental implant method of claim 10, wherein the circular lip of the dental implant comprises a plurality of serrated edges, and wherein the serrated edges are configured to seat into the circular implant retention groove and embed into additional bone at a distal end of the circular implant retention groove.

20. A dental implant method, comprising:
using only one osteotomy trephine drill, drilling an implant hole having an implant hole diameter into a jaw bone at an implant site;
using the osteotomy trephine drill, scoring a circular implant retention groove at a bottom floor of the implant hole;
using a site preparation trephine drill, removing gingiva adjacent to the implant hole to create a ledge portion in a bone surface surrounding the implant hole;
inserting into the implant hole a dental implant having a healing abutment that is removably coupled to a proximal end of the dental implant, wherein the healing abutment includes a projection having a projection diameter that is greater than the implant hole diameter, the dental implant including a circular lip extending axially from a distal end of the dental implant; and
seating the circular lip of the dental implant into the circular implant retention groove at the bottom floor of the implant hole.
